(19) United States
(12) Patent Application Publication
(10) Pub. No.: US 2006/0269797 A1
(43) Pub. Date: Nov. 30, 2006

(54) Perpendicular magnetic recording media including a uniform exchange enhancement layer

(75) Inventors: Bin Lu, Pittsburgh, PA (US); Ganping Ju, Wexford, PA (US); Ashwin Sunder, Pittsburgh, PA (US); Dieter Klaus Weller, Gibsonia, PA (US)

Correspondence Address: PIETRAGALLO, BOSICK & GORDON LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 11/138,622

(22) Filed: May 26, 2005

(51) Int. Cl. G11B 5/65

(52) U.S. Cl. 428/834; 428/833.1; 428/836.2; 428/836.3

(57) ABSTRACT

An apparatus comprises a substrate, a soft underlayer on the substrate, an interlayer on the soft underlayer, a magnetic layer on the interlayer, wherein the magnetic layer has a granular structure comprising magnetic grains separated by non-magnetic grain boundaries, and an exchange enhancement layer formed on the surface of the granular magnetic layer.

### FIELD OF THE INVENTION

This invention relates to magnetic storage media and more particularly to perpendicular magnetic storage media.

### BACKGROUND OF THE INVENTION

Perpendicular magnetic recording discs typically include a substrate, one or more soft magnetic underlayers, a magnetic recoding layer, and a protective overcoat. The magnetic recording layer has a perpendicular magnetic anisotropy. The protective overcoat protects the magnetic recording layer from corrosion and reduces frictional forces between the disc and a read/write head. In addition, a thin layer of lubricant may be applied to the surface of the protective overcoat to enhance the tribological performance of the head-disc interface by reducing friction and wear of the protective overcoat.

Granular perpendicular magnetic recording media is being developed for its capability of further extending the areal density of stored data, as compared to conventional perpendicular media, which is limited by the existence of strong lateral exchange coupling between magnetic grains. A granular perpendicular recording medium comprises a granular perpendicular magnetic layer having magnetic columnar grains separated by grain boundaries comprising voids, oxides and/or nitrides. The grain boundaries, having a thickness of about 2 Å to about 20 Å, provide a substantial reduction in the magnetic interaction between the magnetic grains. In contrast to conventional perpendicular media, wherein the perpendicular magnetic layer is typically sputtered at low pressures and high temperatures in the presence of an inert gas, such as argon (Ar), deposition of the granular perpendicular magnetic layer is conducted at relatively high pressures and low temperatures and utilizes a reactive sputtering technique wherein oxygen (O₂) and/or nitrogen (N₂) are introduced in a gas mixture of, for example, Ar and O₂, Ar and N₂, or Ar and O₂ and N₂. Alternatively, oxygen or nitrogen may be introduced by utilizing a sputter target comprising oxides and/or nitrides, which is sputtered in the presence of an inert gas (e.g., Ar), or, optionally, may be sputtered in the presence of a sputtering gas comprising O₂ and/or N₂ with or without the presence of an inert gas. Not wishing to be bound by theory, the introduction of O₂ and/or N₂ provides oxides and/or nitrides that migrate into the grain boundaries, thereby providing a granular perpendicular structure having a reduced lateral exchange coupling between grains.

Inter-granular exchange coupling (Hₑₓ) is a key parameter in developing ultrahigh density perpendicular magnetic recording media. A large Hₑₓ will act to couple neighboring grains to form magnetic clusters, which are larger than the physical grains. When a magnetic field is applied to the media, the clusters may switch together, effectively increasing the size of the switching volume by forming magnetic clusters. As a result, the cross-track correlation length (s) and bit transition length (a) will increase, which causes the recorded bits to have poorly defined boundaries and positions. This compromises the precision with which neighboring transitions can be placed, and as a consequence, increases the transition position jitter σⱼ, where the jitter σⱼ²˜a²s.

In addition to jitter, the switching field distribution (dM/dH_{head}) is another dominant factor in achieving clean and sharp bit transitions. Adding exchange coupling can make the switching behavior of the media grains more consistent at the expense of increasing the bit volume. An appropriate amount of Hₑₓ may reduce the breadth of switching field distribution in perpendicular media due to the demagnetization field. As a result, a narrower bit transition length may be achieved under William-Comstock assumptions, where granularity of media is not included.

The conventional way of introducing inter-granular exchange into media is to decrease the average physical spacing between the grains. In media fabrication, this means reducing the portion of voids or non-magnetic materials at the grain boundaries. For example, reducing the Ar pressure during magnetic sputtering can mitigate the shadowing effect, which gives rise to more densely packed grains. Also, reducing the oxide amount during co-sputtering of the oxide and CoPt will lead to thinner grain boundaries. However, there is always a distribution of grain boundary thickness. When the average inter-granular spacing is reduced, there will be more grains touching each other. When grains are touching, the exchange coupling between the grains increases significantly. The strength of the exchange field between two grains depends on their contact area and separation distance, and there will be a distribution of inter-granular exchange coupling. In addition, the strongly exchange coupled grains cannot be decoupled by the head field gradient, while weakly coupled grains can. This will add to irregularity in the transitions and track boundaries, and cause large cross-track correlation lengths.

Therefore there is a need for a way to control the inter-granular exchange coupling in order to optimize the media recording performance.

### SUMMARY OF THE INVENTION

This invention provides an apparatus comprising a substrate, a soft underlayer on the substrate, an interlayer on the soft underlayer, a magnetic layer on the interlayer, wherein the magnetic layer has a granular structure comprising magnetic grains separated by non-magnetic grain boundaries, and an exchange enhancement layer formed on the surface of the granular magnetic layer.

### BRIEF DESCRIPTION OF THE DRAWINGS

FIG. 1 is a schematic representation of a magnetic storage medium constructed in accordance with the invention.

FIG. 2 is a cross-section of a thin film layer structure constructed in accordance with the invention.

FIG. 3 is a graph of bit length, cross-track correlation length, and jitter with varying magnetic coupling.

FIG. 4 is a hysteresis loop of an exchange decoupled media.

FIG. 5 is a hysteresis loop of a media with increased exchange coupling.

FIG. 6 is a series of hysteresis loops of the media with increasing Pt cap thickness.

FIG. 7 is a graph of alpha parameter against the Pt cap thickness.

FIG. 8 is a graph of the RMS read-back signal at 600 kFCI versus Pt cap thickness.

FIG. 9 is a graph of ΔeSMNR vs. alpha indicating poorer on-track performance when exchange increases.

FIGS. 10 and 11 are graphs of MOKE sweep rate results showing KᵤV/kT and H₀ trend against Pt cap thickness.

FIG. 12 shows hysteresis curves of a fully-decoupled medium and a fully-decoupled media with 1 nm Pt.

FIG. 13 shows a MOKE sweep rate measurement showing dynamic coercivity versus attempted switching time.

FIG. 14 is a graph of eSMNR of media against the Pt cap thickness.

FIG. 15 is a graph showing dibit extraction applied to a sample Pt capped granular oxide media.

FIG. 16 shows the dipulse extraction signal peak versus Pt cap thickness.

FIGS. 17 and 18 show dynamic coercivity results of the Pt cap thickness series.

FIG. 19 is a graph showing log BER cross-track performance of the Pt capped media.

### DETAILED DESCRIPTION OF THE INVENTION

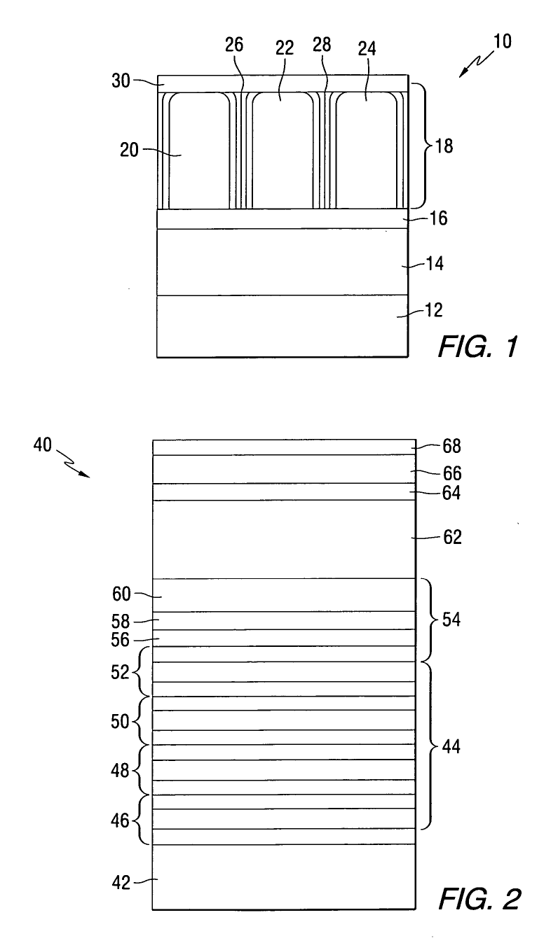

FIG. 1 is a cross-sectional view of a magnetic storage medium 10 constructed in accordance with this invention. The medium includes a substrate 12 that can be, for example, glass. A soft magnetic underlayer 14 is formed on the substrate and may comprise a plurality of layers. An interlayer 16 is positioned on the soft underlayer. A magnetic recording layer 18 is positioned on the interlayer. The magnetic recording layer includes a plurality of grains 20, 22 and 24 of magnetic material and a plurality of boundaries 26, 28 of non-magnetic material, such as oxides, nitrides, or other non-magnetic material, that separate the grains of magnetic material. An exchange coupling enhancement layer 30, also called a cap layer, is positioned on the magnetic recording layer. A protective layer and lubricating layer (not shown in this view) can be applied to the top of the cap layer.

The soft underlayer (SUL) is the layer that conducts the magnetic flux from a recording head in the writing process. The interlayer (IL) sets up the orientation and microstructure of the adjacent magnetic layer, which has a very well decoupled grain structure. The cap layer is the exchange coupling enhancement layer. In a practical embodiment, a diamond like carbon overcoat and lubricant would be added on top of the cap layer to make a flyable media.

Media constructed in accordance with this invention includes a cap layer of spin polarization material that is used to adjust the amount of exchange coupling in the media grains. In one example the material can be platinum (Pt), but other spin polarizing materials such as Rh and Pd can also be used. Micromagnetic modeling has demonstrated that a small amount of exchange coupling between grains of a storage medium helps reduce the bit transition length (a), also referred to as the a parameter.

This invention introduces inter-granular exchange by uniformly coupling the grains with a weak exchange field. This not only helps to narrow the switching field distribution, but also allows the head field gradient to locally break exchange and record transitions. In this scenario, the transition width and cross-track correlation length are only limited by the intrinsic grain size and distribution. Normal magnetic materials, such as Co, Ni, Fe or their alloys or Co/Pt multilayers have large magnetization and the resulting exchange introduced may not fall into the appropriate range. Adding a capping layer on top of fully-decoupled magnetic grains is a promising approach to achieving uniform exchange coupling.

In one embodiment, this invention uses a thin Pt capping layer on top of a Co₃Pt-type granular magnetic layer to increase the exchange coupling between the magnetic grains. The strength of the exchange strongly depends on the Pt capping layer thickness and saturates at thicknesses above about 4 nm. The read-back signal of recorded bits shows a discontinuous jump at about 1 nm Pt capping layer thickness, indicating a polarization effect of Pt at the Pt/Co₃Pt interface. These findings provide an approach for introducing a uniform exchange between the grains of perpendicular magnetic recording media. Consequently, by controlling the inter-granular coupling, the transition parameter and cross-track correlation length may be adjusted to achieve the highest possible recording density.

FIG. 2 is a cross-section of a magnetic recording disc 40 constructed in accordance with the invention. Several such discs were fabricated. The discs include a substrate 42 and a multilayer soft magnetic underlayer 44 positioned on the substrate. Thin film deposition was carried out at room temperature. The soft magnetic underlayer (SUL) having a thickness of 200 nm, was deposited first. The SUL includes 4 repetitions 46, 48, 50 and 52 of (Ta 1 nm\FeCoB 50 nm\Pt 1 nm\air). The discs were taken out of chamber between each repetition.

The SUL-coated discs were reinserted into the chamber for magnetic deposition. An interlayer 54 was deposited on the SUL. First, a layer 56 of 2 nm thick Pt was used to cover the air-exposed surface. Atoms of this fcc structured layer have high mobility during growth, hence they set a (111) preferred orientation (PO) for the subsequent hcp layers to retain the (00.2) PO. The interlayer includes a bilayer structure having a 2 nm layer 58 of CoCrRu and a 6 nm layer 60 of Ru. The magnetic layer 62 was co-deposited using three concentric ring targets. The outer ring was pure Co, the middle ring was Pt and the center disc was oxide target, such as SiO₂. The center disc was deposited by RF sputtering, and the other two rings used DC sputtering. The SiO₂ was used to control the grain boundary width, hence the decoupling of the CoPt grains. The composition of CoPt is adjusted by compromising the stacking fault density (Hₖ distribution) and average Hₖ value. Here Co₇₉Pt₂₁ is used.

After deposition of the magnetic layer and a 2 nm Pt cap 64, a 4.5 nm thick carbon overcoat (COC) 66 was deposited. The finished discs were subsequently post-sputter processed to add a lube, buff/wipe, or burnish/glide layer 68.

Magneto-Optical Kerr Effect (MOKE) magnetometry measurements were used to measure hysteresis loops of the media. The maximum applied field was 20 kOe. The sweep rate was set to about 2000 Oe/s. The coercivity (H_{C}), remanence squareness (S=Mᵣ/Mₛ), loop slope α(α=4πdM/dH|_{H=Hc}) and nucleation field (H_{N}) were extracted.

The media short-time coercivity (H₀) and thermal stability factor (KᵤV/k_{B}T) were measured using sweep rate (R) dependent MOKE hysteresis loop measurements, with R varying from 10 to 1000 Oe/sec. A direct correlation between the effective applied field time (t_{eff}) and R can be found easily using known techniques, as t_{eff}=H_{f}/R, where H_{f} is the thermal fluctuation field that can be determined from the slope of H_{c} v.s. ln(R). The short-time coercivity (H₀) and thermal stability factor (KᵤV/k_{B}T) were then determined using Sharrock's formula:

$${H}_{C} ( t ) = {H}_{0} \{ 1 - {[ \frac{{k}_{B} T}{{K}_{U} V} ln ( \frac{{f}_{0} t}{ln 2} ) ]}^{\frac{1}{2}} \}$$

All spinstand testing of the media was carried out on an Agilent spinstand running under the Test Exec SL environment. A 64 kTPI head flying at 5400 RPM at a radius of 0.9″ was used. PRBS signals were recorded onto the media at certain linear densities and various measures, e.g. eSNR, eSMNR, etc. were extracted from the captured waveforms.

The layers of the structure can be comprised of various materials. Substrate materials generally include NiP-plated Al alloy, glass, glass-ceramic, ceramic, or other non-magnetic materials. The substrate may also be a textured substrate, such as a conventionally NiP-plated textured aluminum substrate or a textured glass-ceramic substrate. Adhesion enhancement layer materials include tantalum (Ta), titanium (Ti), titanium-chromium (TiCr), chromium (Cr) and other metals. The soft magnetic layer comprises magnetically soft materials generally including iron (Fe) and cobalt (Co) alloys, for example alloys of iron and nickel (FeNi), alloys of iron and nitrogen (FeN), alloys of iron, tantalum and carbon (FeTaC), alloys of iron, tantalum and nitrogen (FeTaN), alloys of iron and cobalt (FeCo), alloys of iron, cobalt and boron (FeCoB), alloys of iron, silicon and aluminum (FeSiAl), alloys of cobalt, zirconium and niobium (CoZrNb), and alloys of cobalt, zirconium and tantalum (CoZrTa). Applicable seed layer materials include tantalum (Ta), silver (Ag), copper (Cu), gold (Au), and platinum (Pt). The interlayer may include ruthenium (Ru), Ru alloys, such as RuCr, RuCoCr, and non-magnetic cobalt-chromium (CoCr) optionally having a third element selected from the group comprising Pt, molybdenum (Mo), Ta, niobium (Nb), boron (B), carbon (C), and Ru. The interlayer provides a crystalline seed layer for the subsequently deposited magnetic layer. The granular magnetic layer includes Co-based alloys comprising oxides and nitrides, for example cobalt-platinum oxides (CoPtO), cobalt-chromium-platinum oxides (CoCrPtO), cobalt-chromium-platinum-tantalum oxides CoCrPtTaO, cobalt-platinum-titanium oxides (CoPtTiO), cobalt-chromium-platinum-titanium oxides (CoCrPtTiO), cobalt-chromium-platinum-aluminum oxides (CoCrPtAlO), cobalt-platinum-silicon oxides (CoPtSiO), cobalt-chromium-platinum-zirconium oxides (CoCrPtZrO), cobalt-chromium-platinum-hafnium oxides (CoCrPtHfO), cobalt-chromium-platinum-niobium oxides (CoCrPtNbO), cobalt-chromium-platinum-boron oxides (CoCrPtBO), cobalt-chromium-platinum-silicon oxides (CoCrPtSiO), cobalt-platinum-silicon nitrides (CoPtSiN), cobalt-platinum-tungsten nitrides (CoPtWN), cobalt-chromium-platinum-tantalum nitrides (CoCrPtTaN), cobalt-platinum-tantalum nitrides (CoPtTaN), and cobalt-chromium-platinum-silicon nitrides (CoCrPtSiN), wherein the granular magnetic layer comprises oxygen and/or nitrogen in a concentration of about 3 atomic % to about 40 atomic %, preferably in the range of about 5 atomic % to about 25 atomic %. A protective overcoat can be applied over the granular magnetic layer, such as a carbon-containing protective overcoat, and a lubricant layer may be applied thereon.

The grains can have a size in the range of 3-10 nm, and the oxide containing magnetic layer can have a thickness in the range of 3-20 nm.

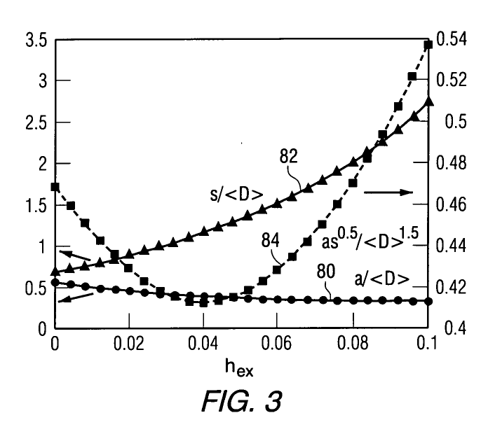

FIG. 3 is a graph of the bit transition length, referred to as the a parameter and illustrated by curve 80, the cross-track correlation length, referred to as the s parameter and illustrated by curve 82, and the jitter, illustrated by curve 84, which varies with the amount of hₑₓ=Hₑₓ/Hₖ. FIG. 3 shows the effect of inter-granular exchange, hₑₓ on both a and s and the jitter which is proportional to a combination of the a and s parameters. Since jitter characterizes the recording quality of the position of magnetic transitions in the media, its value indicates the ultimate possible recording density of the writer-media combination. It can be seen that in this particular case, minimum jitter is reached at some amount of hₑₓ. Here hₑₓ is Hₑₓ/Hₖ.

Inter-granular exchange can be adjusted by controlling the amount of oxide in the magnetic layer, which adjusts the width of grain boundaries in a non-uniform way. Or it can be adjusted by adding a continuous uniform exchange layer on top of the magnetic grains. The thickness of the continuous uniform exchange layer controls the inter-granular exchange. If only the grain boundaries are adjusted, the contact area between neighboring magnetic grains may vary from zero to full side-by-side contact. This will create a large distribution of exchange interactions between grains; hence a larger distribution of switching volumes (i.e., magnetic cluster sizes) and switching field magnitudes.

This invention uses a uniform exchange enhancement layer on a granular magnetic recording layer, wherein the granular layer includes a plurality of grains separated by non-magnetic boundaries. The non-magnetic boundaries can be, for example, oxides, nitrides or other non-magnetic materials. The use of a top exchange layer provides several advantages. For example, it lowers the switching field, and hence improves the writability of the media. It reduces the distribution of switching fields by adding exchange coupling to clean and sharpen the bit transitions. It enhances the squareness of the hysteresis loop, i.e., it increases the remanence field if the loop does not have full squareness. This lowers the remanence noise.

The amount of exchange can be controlled by controlling the thickness of the top exchange layer. This provides flexibility in designing media spacing. The amount of decoupling between grains can be adjusted by adjusting the magnetic layer grain boundaries and the amount of coupling can be adjusted by adjusting the cap layer. The cap layer can also serve as a corrosion protective layer and surface smoothing layer. The cap layer can be part of the magnetic layer, and therefore would not increase head-media spacing.

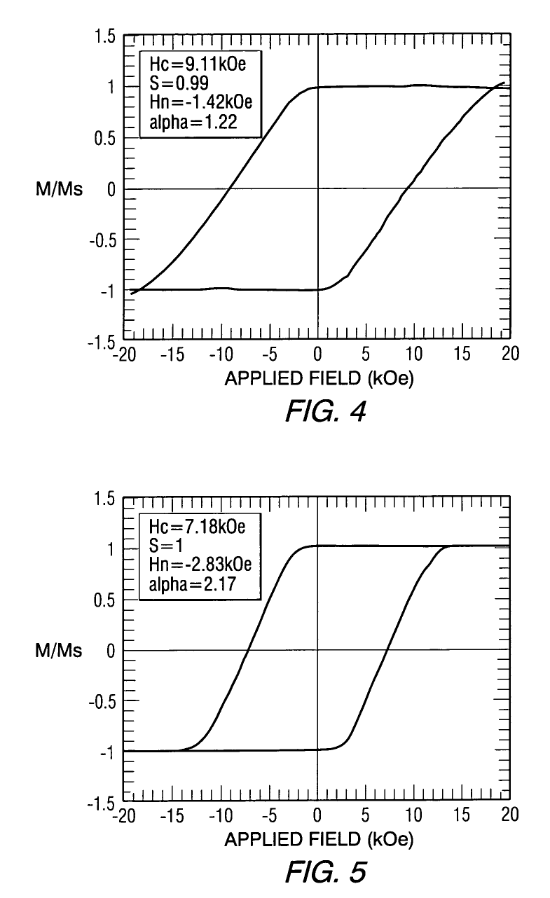

FIG. 4 is a hysteresis loop of an exchange decoupled media having the following structure: Glass\Ta 3 nm\Cu 2 nm\CoCr25Ru50 5 nm\Ru 7 nm\CoPtO (oxide 28 vol. %) 13 nm\COC 7 nm. The Mₛ is determined to be about 750 emu/cc. From FIG. 4, it can be seen that the media has a coercivity H_{c}=9.11 kOe, and a squareness S=Mᵣ/Mₛ=1.0, and the slope of the loop alpha=dM/dH|_{H=Hc}=1.22.

FIG. 5 is a hysteresis loop of a media with increased exchange coupling, and having the following structure: Glass\Ta 3 nm\Cu 2 nm\CoCr25Ru50 5 nm\Ru 7 nm\CoPtO (oxide 28 vol %) 13 nm\Pt 5 nm. FIG. 5 shows a hysteresis loop of the same medium as in FIG. 4 except for a cap layer of 5 nm Pt. FIG. 5 shows that the shape of the loop changes dramatically such that Hc=7.18, S=1.0, Hn=2.83, and alpha=2.17. The increase of the slope of the loop is direct evidence of enhanced exchange coupling between the magnetic grains.

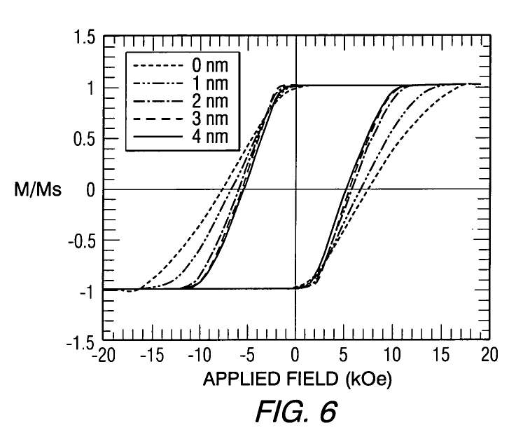

FIG. 6 is a series of hysteresis loops of the media with increasing Pt cap thickness. FIG. 6 shows data for a flyable media series, which is not the same sample series as in FIGS. 4 and 5. It can be seen that the slope of the loop increases as the cap thickness increases. In the meantime, H_{c} decreases as the cap thickness increases.

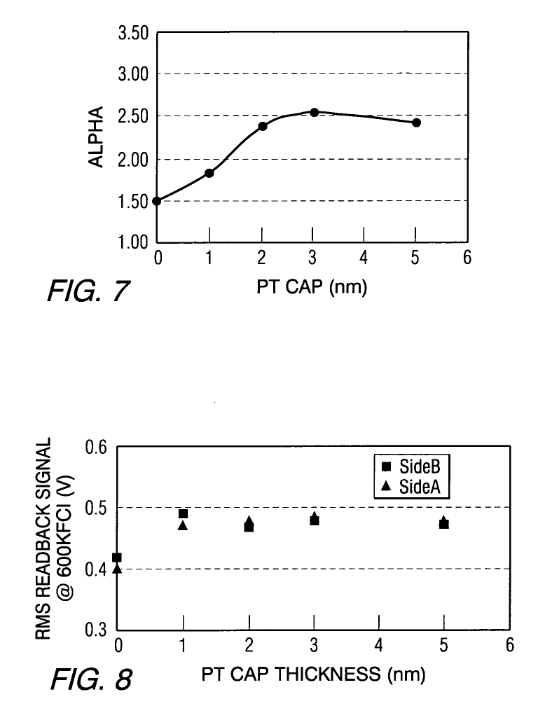

FIG. 7 is a graph of alpha parameter versus the Pt cap thickness. FIG. 7 shows that the slope saturates beyond about a 2 nm thickness.

FIG. 8 is a graph of the RMS read-back signal at 600 kFCI versus Pt cap thickness. A pseudo-random bit sequence signal was written by using a 64 kTBI head at 5400 rpm with a linear density of 6000 kFCI. It can be seen that the read-back signal increases with a 1 nm Pt cap layer thickness and then saturates. This indicates that Pt participates in the recording process and becomes part of magnetic layer. This clearly demonstrates the polarization effect of the cap layer.

From the above description, it is apparent that the Pt cap layer provides a uniform exchange layer on top of the media grains. The cap layer material and thickness can be adjusted to optimize the amount of exchange and amount of inter-granular grain decoupling, consequently adjusting the transition parameter and cross-track correlation length to achieve the highest possible recording density. This provides a technique for fine tuning the media performance.

To achieve optimized media performance, it is important to establish a quantitative measurement of exchange coupling strength. In a recent effort to quantify exchange coupling strength, a linear correlation between the total exchange field (Hₑₓ) and the loop slope parameter α (α=4πdM/dH|_{H=Hc}) has been found, with a correlation slope close to 1 and an offset less than 1 kOe depending on media models being used. To a first order, the total exchange interaction field can be calculated from Hₑₓ=4πM_{S}(1-1/α), and the normalized exchange coupling strength can be determined as hₑₓ=Hₑₓ/(N*H_{K}), where Hₖ is the anisotropy field and N is the number of neighboring interacting grains, typically close to 6. For advanced granular oxide perpendicular media, hₑₓ is typically between 0.05 and 0.1 for media with full squareness (S=1) and negative nucleation field. This exceeds the optimum level of exchange indicated in FIG. 3. On the other hand, there are media designs with more oxide doping and as a result, smaller exchange can be reached at thicknesses between 0 and 0.5 nm. However, the squareness of such media is typically less than 1. When media is designed to have squareness (S)<1, exchange coupling can be added to increase the remanence of the media in order to reduce DC noise.

In another important aspect, exchange coupling reduces the coercivity (H₀) of the media, and therefore improves writeability. H₀ is the short-time coercivity of the media. The currently used CoPt granular media has Mₛ as high as 750 emu/cc (per total volume, with the packing fraction included). A fully-decoupled media will have H₀≧4πMs=9.4 kOe, and Hₛₐₜ≧18.8 kOe. A high anisotropy design, where Hₖ>Hₛₐₜ, is required to obtain perpendicular remanence. However, such large saturation fields exceed the write field of today's available perpendicular heads (˜12 kOe). Introducing exchange coupling can reduce H₀ and Hₛₐₜ. In the above example, alpha (the slope of the hysteresis loop) needs to be increased from 1 to 1.6, for hₑₓ from 0 to 0.03, assuming N=6, Hₖ=20 kOe, in order to bring the Hₛₐₜ down from 18.8 kOe to 12 kOe.

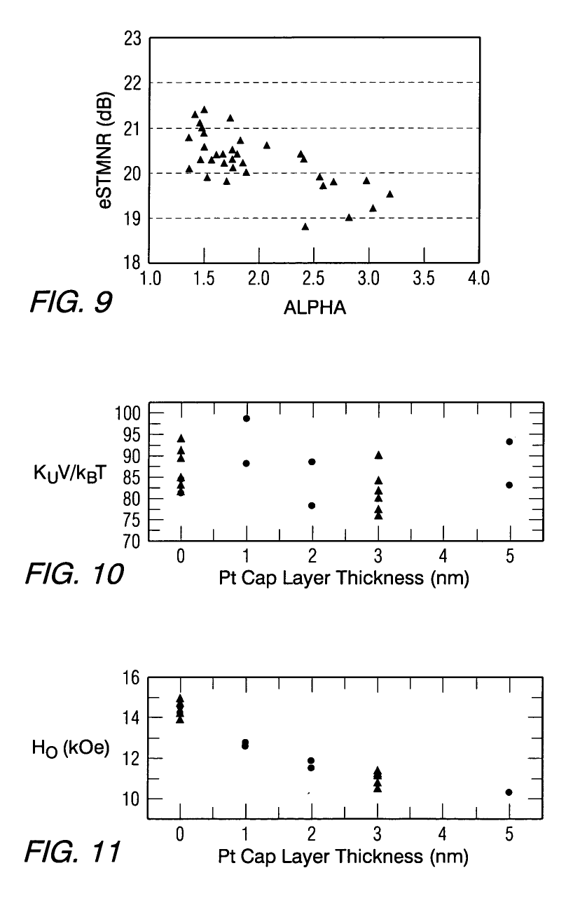

FIG. 9 is a graph of eSMNR vs. alpha indicating poorer on-track performance when exchange coupling increases, for conventional PMR granular oxide media, in which the coupling has been reduced by increasing the amount of oxide. The testing was performed using a 64 kTPI head. The alpha was varied by varying the amount of oxide in the magnetic layer.

It can be seen that the recording performance generally deteriorates as the alpha increases. This can be explained in two ways. First, the way of introducing exchange was not uniform. It was mostly achieved by reducing the amount of the oxide. Second, the value of alpha does not drop below 1.3. There is still room to further reduce the exchange and reduce alpha to 1. In other words, to see the benefit of exchange coupling, we need to compare cases when hₑₓ=0 and hₑₓ=0.04. More importantly, the hₑₓ=0.04 should be introduced by a uniform exchange feature, such as Pt capping. FIG. 9 shows a need to separate the effect of Pt cap from the oxide in order to interpret the data.

FIGS. 10 and 11 are graphs of MOKE sweep rate results showing KᵤV/kT and H₀ trends against Pt cap thickness. It is seen that the thermal stability coefficient KᵤV/k_{B}T stays more or less constant as the Pt cap thickness increases. This indicates that the type of exchange coupling introduced between magnetic layers will not increase the magnetic switching volume. On the other hand, the increase in Pt cap thickness dramatically decreases the short-time coercivity H₀. This will improve the writeability of the media.

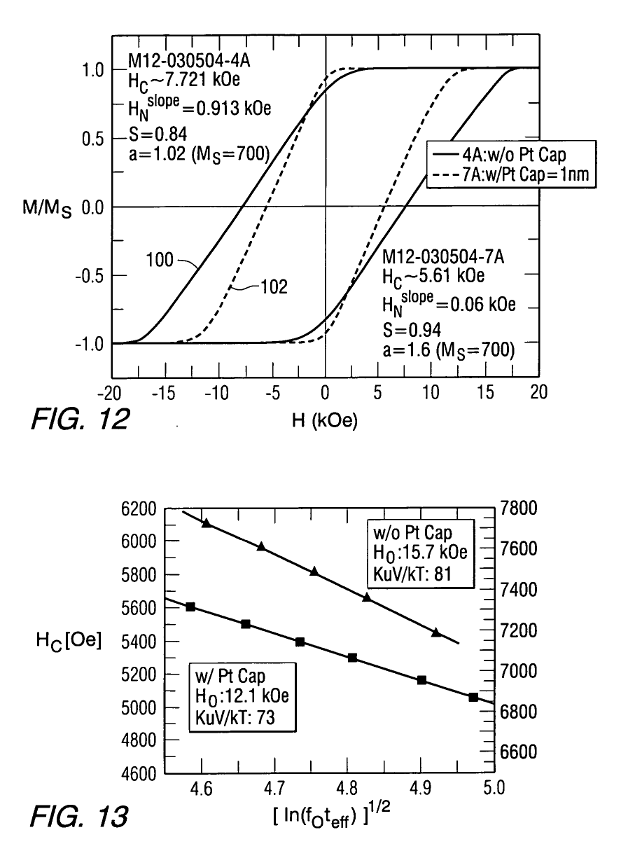

FIG. 12 is a hysteresis curve of a fully-decoupled medium and the fully-decoupled media with a 1 nm Pt cap layer. Curve 100 relates to a fully-decoupled medium with alpha=1.02, Hc=7.7 kOe, S=0.84 and the medium for curve 102 is the same as for curve 100 except for 2 nm of Pt cap. R_{c}=5.61 kOe, S=0.94, and alpha=1.6. In this case we increased the media squareness from 0.84 to 0.94 by adding a 2 nm Pt cap.

FIG. 13 illustrates a MOKE sweep rate measurement showing dynamic coercivity versus attempted switching time. FIG. 13 shows the dynamic Hc measurements by the MOKE sweep rate method on the same two media as in FIG. 12. The plot shows a reduction of the short-time coercivity H₀ from 15.7 kOe to 12.1 kOe when 2 nm Pt cap is added.

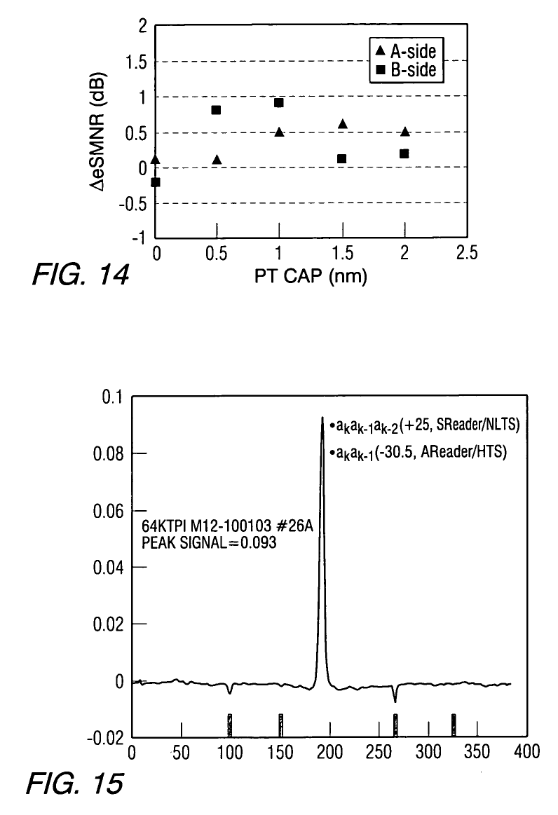

FIGS. 14, 16, 17 and 18 show data for the same sample set. FIG. 14 is a graph of eSMNR of media against the Pt cap thickness. FIG. 14 shows fine steps of increasing Pt cap thickness and its effect on recording performance, which is represented by signal to media noise ratio, eSMNR. FIG. 14 shows that about a 1 dB increase of eSMNR can be realized by applying the Pt cap layer. This demonstrates the possibility of fine tuning the exchange states in the media and its benefit to the media performance.

FIG. 15 shows the dibit extraction technique applied to one of the Pt capped granular oxide media (2 nm Pt cap). The vertical lines at the bottom of FIG. 15 represent calculated locations for various kinds of non-linear echoes. The height of the main signal peak represents the strength of the dibit response, which in turn is a function of the read-back signal. Thus, the strength of the read-back signal as a function of the thickness of the Pt capping layer can be derived in two ways: a) using the height of the dipulse peak, as calculated above, and b) calculating the RMS signal strength of a PRBS pattern.

FIG. 16 shows the dipulse extraction signal peak versus Pt cap thickness. In FIG. 16, the increase in the dipulse peak signal strength in going from 0 nm to 1 nm of Pt capping layer is a clear indication of the active, polarizing nature of the Pt cap. The reason that the dipulse peak strength decreases with further increases in Pt cap thickness is because the Pt broadens the peak (increases PW50), and thus the peak amplitude falls.

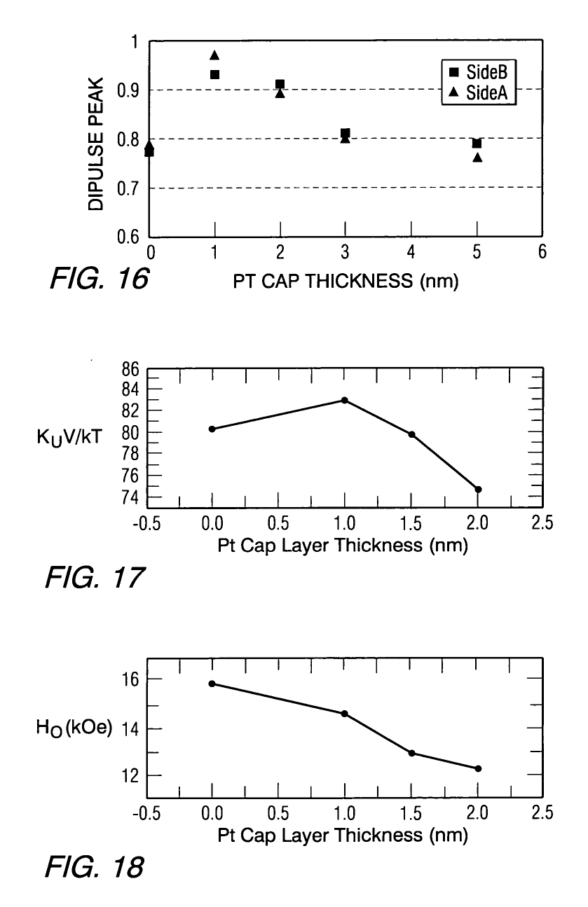

FIGS. 17 and 18 show dynamic coercivity results of the Pt cap thickness series, showing similar trends as in FIGS. 10 and 13.

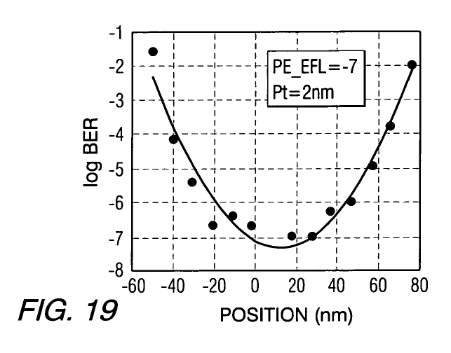

FIG. 19 is a graph showing log BER cross-track performance of the Pt capped media at 850 kBPI. The bit error rate (BER) is in the range of 10⁻⁷. The narrow bath tub curve indicates that the Pt capped media has excellent cross-track performance.

The Pt cap layer can be used to continuously adjust the exchange coupling between the magnetic grains (a=1-2.5) by varying cap thickness. The Pt cap layer provides a uniform exchange layer on top of the magnetic grains. It can adjust media writeability, squareness, and inter-granular exchange coupling to match the recording head design. It provides a means to explore wider media design space. It also can fine tune the media properties to maximize on-track and cross-track performance.

This invention uses a uniform exchange enhancement layer on a granular magnetic recording layer, wherein the granular layer includes a plurality of grains separated by oxide boundaries. While the described examples use a Pt cap layer, other spin polarizing materials, such as, Pd, Rh, Pd, Co, Ni, and Fe can also be used as the cap. In addition, the exchange enhancement layer can be comprised of a plurality of layers.

While the invention has been described in terms of several examples, it will be apparent to those skilled in the art that various changes can be made to the disclosed examples without departing from the scope of the invention as set forth in the following claims.

What is claimed is:

1. An apparatus comprising:
a substrate;
a soft underlayer on the substrate;
an interlayer on the soft underlayer;
a magnetic layer on the interlayer, wherein the magnetic layer has a granular structure comprising magnetic grains separated by non-magnetic grain boundaries; and
an exchange enhancement layer formed on the surface of the granular magnetic layer.

2. The apparatus of claim 1, wherein the non-magnetic grain boundaries comprise at least one of: an oxide, a nitride, or another non-magnetic material.

3. The apparatus of claim 1, wherein the exchange enhancement layer comprises one of: Pt, Ru, Pd, Co, Ni, and Fe.

4. The apparatus of claim 1, wherein the exchange enhancement layer comprises a plurality of layers.

5. The apparatus of claim 1, wherein the exchange enhancement layer has a thickness in the range of 0.5 nm to 5 nm.

6. The apparatus of claim 1, wherein the magnetic layer includes a cobalt-based alloy.

7. The apparatus of claim 1, further comprising:
a protective overcoat formed over the surface of the exchange enhancement layer.

8. The apparatus of claim 1, wherein the grain boundaries have a thickness in the range of about 2 Å to about 20 Å.

9. The apparatus of claim 1, wherein the at least one interlayer comprises at least one of Ru, RuCr, and non-magnetic CoCr.

10. The apparatus of claim 1, wherein the magnetic grains are fully-decoupled.

11. The apparatus of claim 1, wherein the magnetic grains have a size in the range of about 3 nm to about 10 nm.

12. The apparatus of claim 1, wherein the granular magnetic layer includes oxygen and/or nitrogen in a concentration of about 3 atomic percent to about 40 atomic percent.

13. The apparatus of claim 1, wherein the granular magnetic layer includes oxygen and/or nitrogen in a concentration of about 10 atomic percent to about 30 atomic percent.
